(19) United States
(12) Patent Application Publication
(10) Pub. No.: US 2026/0155967 A1
(43) Pub. Date: Jun. 4, 2026

(54) ARTIFICIAL NEURAL NETWORK INNER PRODUCT FUNCTIONAL ENCRYPTION

(71) Applicant: Lenovo (Beijing) Limited, Beijing (CN)

(72) Inventors: Chunling Han, Changping District, Beijing (CN); Igor Stolbikov, Apex, NC (US); Scott Li, Cary, NC (US); Christian De Hoyos, Morrisville, NC (US)

(21) Appl. No.: 19/123,228

(22) PCT Filed: Nov. 7, 2022
(86) PCT No.: PCT/CN2022/130211

§ 371 Date: Apr. 22, 2025

(51) Int. Cl. H04L 9/08

(52) U.S. Cl. CPC H04L 9/088

(57) ABSTRACT

A system and process analyze data in an artificial neural network by receiving the data into the artificial neural network, and functionally encrypting the data at a plurality of inner input nodes in the artificial neural network. The functionally encrypted data are processed in the artificial neural network, and an output is generated from the processing of the functionally encrypted data in the artificial neural network.

### TECHNICAL FIELD

Embodiments described herein generally relate to inner product functional encryption on an artificial neural network, and in an embodiment, but not by way of limitation, inner product functional encryption on an artificial neural network for medical image privacy protection and analysis.

### BACKGROUND

Medical imaging, such as chest x-rays, is very useful for getting a better understanding of diseases and other health issues. However, patients' medical records that include data such as x-rays contain very sensitive information. Consequently, health care professionals need to be extremely careful when handling medical data due to privacy concerns.

Deep learning is a very accurate and effective method for x-ray scan analyses. Deep learning can extract features from a set of x-rays, and then it can use the features to train a deep learning model. After the training process, a new x-ray can be submitted to the trained model to get a very accurate analysis. Sometimes, the analysis results can be more accurate than experienced doctors.

There has been some attempts to solve the privacy problem associated with medical data and the use of deep learning, such as anonymization and randomization, secure two-party or multiparty computation, and homomorphic encryption. To protect users' privacy, many existing methods use anonymization and randomization of sensitive information to protect privacy by removing identifiers such as names, addresses, and ages or adding noise to original sensitive data. However, there are some indications that the remaining data combined with some extra databases can re-identify individuals.

The use of secure multiparty computation in machine learning is very inefficient and can involve many interactions between parties, especially when involving a great amount of data. The numerous computational tasks and numerous interactions back and forth for parties extremely reduces the efficiency of machine learning.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates an artificial neural network and the learning and predicting phases of the artificial neural network.

FIG. 2 illustrates a computation in the first layer of the artificial neural network of FIG. 1.

FIG. 3 is a block diagram illustrating operations and features of a system and process for functionally encrypting data in an artificial neural network for training and predicting.

FIG. 4 is a block diagram of a computer architecture that can be used in one or more embodiments of the current disclosure.

### DETAILED DESCRIPTION

This disclosure relates to solving the problem of privacy protection when using deep learning, such as when analyzing x-ray, other medical data, and any other data wherein there is a privacy concern.

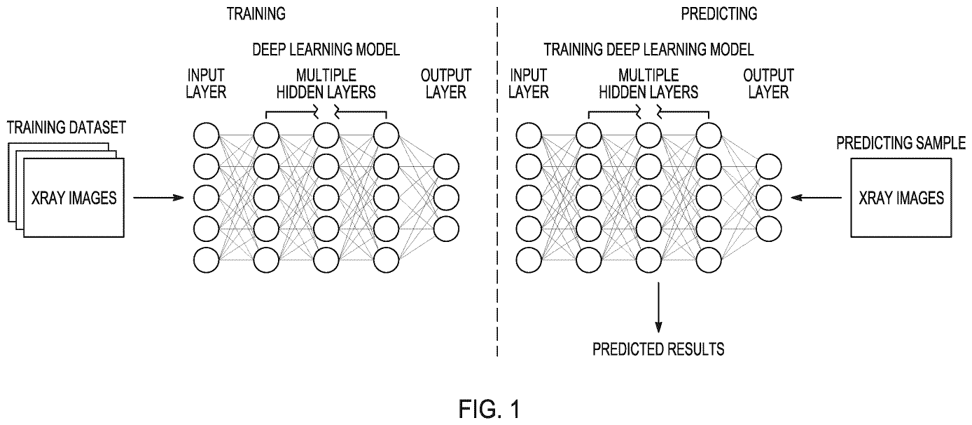

In an embodiment, a deep learning model receives medical images and labels for those images as input, and the deep learning model is trained for many iterations. After the training phase, the trained deep learning model receives data input, processes that data input, and generates accurate results. FIG. 1 illustrates the training and predicting process for a deep learning model used for an x-ray scan analysis.

In FIG. 1, x-rays are the patients' sensitive data. When the deep learning model learns about the medical images and predicts based on that learning, sensitive features can be remembered in the model. To provide privacy protection, an embodiment interacts with the computation in every node in the deep learning model.

The first layer of the deep learning model receives the input medical images X. Every node of the deep learning artificial neural network includes parameters W and b (although b is not required), and the computation for the first hidden layer is:

$$z = {W}^{T} X + b$$

The result g(z) is the input for the next hidden layer.

To protect sensitive input medical images X, an embodiment does not input X to the first hidden layer. Rather, the system computes Z=W^{T} X an input; that is, an inner product functional encryption.

As known to those of skill in the art, functional encryption uses a functional key. With the functional key, the receiver gains a function value of sender's plaintexts, but nothing else. Inner product functional encryption means that the function in the functional encryption scheme is an inner product of the deep learning artificial neural network.

The algorithm of the inner product functional encryption scheme for an artificial neural network is as follows:
1. Setup: generate public parameters pp and master secret key msk given security parameter λ.

$$pp , msk ← FE . setup ( {1}^{λ} )$$

2. Key Generation: generate functional secret keys sk_{y} for input function y using master secret key msk.

$${sk}_{y} ← FE . keygen ( msk , y )$$

3. Encryption: encrypt message x with master secret key msk into ciphertext c.

$${c}_{x} ← FE . Enc ( msk , x )$$

4. Decryption: evaluate z=xgv from ciphertext cₓ and functional secret key sk_{y} using pp.

$$z ← Fe . Dec ( pp , {sk}_{y} , {c}_{x} )$$

It is noted that the above is just one way to functionally encrypt data. Those of skill in the art are aware of many other ways, and they will use the method that is best suited to their particular situation.

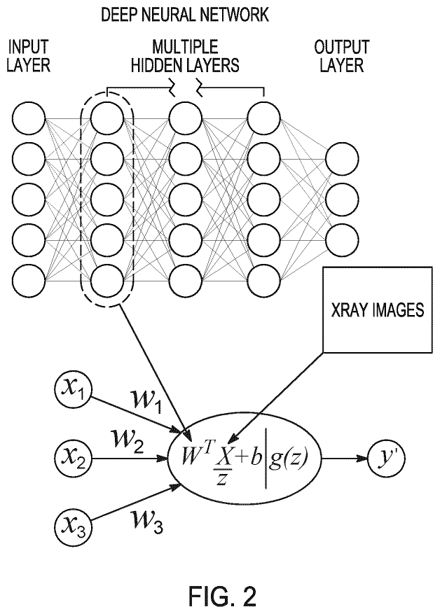

Referring to FIG. 2, to solve the problem discussed above, input W^{T} is input as y and X is input as x. Then, by using inner product functional encryption, the functional results Z=W^{T} X are obtained, but nothing else about the sensitive input medical images X. Inner product functional encryption is very practical, and as noted above, it can be used in many other instances that require the maintenance of data privacy beside medical imaging.

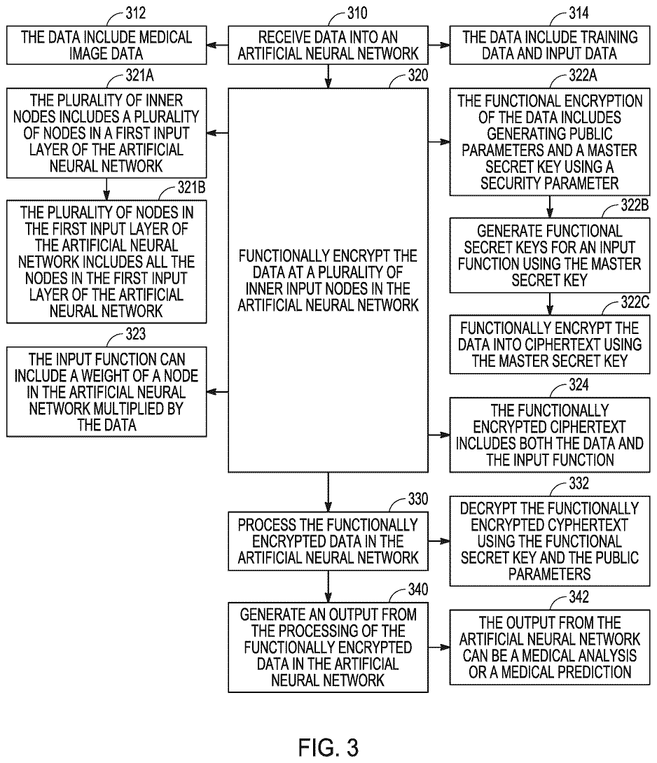

FIG. 3 is a block diagram illustrating operations and features of inner product functional encryption in an artificial neural network. FIG. 3 includes a number of process and feature blocks 310-342. Though arranged substantially serially in the example of FIG. 3, other examples may reorder the blocks, omit one or more blocks, and/or execute two or more blocks in parallel using multiple processors or a single processor organized as two or more virtual machines or sub-processors.

Referring now specifically to FIG. 3, at 310, a process to analyze data in an artificial neural network receives the data into the artificial neural network. As indicated at 312, the data can include medical image data. And as indicated at 314, the data include training data to first train the artificial neural network, and then input data for analysis and/or prediction. That is, the process of using functional encryption in the artificial neural network includes both the training of the neural network and the prediction phase of the neural network.

At 320, the data are functionally encrypted at a plurality of inner input nodes in the artificial neural network. As indicated at 321A, the plurality of inner nodes can include a plurality of nodes in a first input layer of the artificial neural network. And as indicated at 321B, the plurality of nodes in the first input layer of the artificial neural network can include all the nodes in the first input layer of the artificial neural network. By functionally encrypting at the first input layer, there is no need to functionally encrypt again at any other inner layer because the data is then already privacy protected. Decryption also takes place at the first inner layer.

As indicated at 322A, the functional encryption of the data includes generating public parameters and a master secret key using a security parameter. At 322B, functional secret keys are generated for an input function using the master secret key, and at 322C, the data are functionally encrypted into ciphertext using the master secret key. As indicated at 323, the input function can include a weight of a node in the artificial neural network multiplied by the data.

As indicated at 324, the functionally encrypted ciphertext generated by the functional encryption of the data at the plurality of inner input nodes in the artificial neural network generates ciphertext for both the data and the input function of the artificial neural network. The generation of ciphertext for both the data and the input function protects both the data and the input function of the artificial neural network. This then provides privacy and protection to patients' data, and also provides protection to the intellectual property embodied in the structure of the artificial neural network.

At 330, the functionally encrypted data are processed in the artificial neural network. When needed, the functionally encrypted cyphertext is decrypted using the functional secret key and the public parameters (332).

At 340, an output from the processing of the functionally encrypted data in the artificial neural network is generated. As indicated at 342, the output from the artificial neural network can be a medical analysis or a medical prediction.

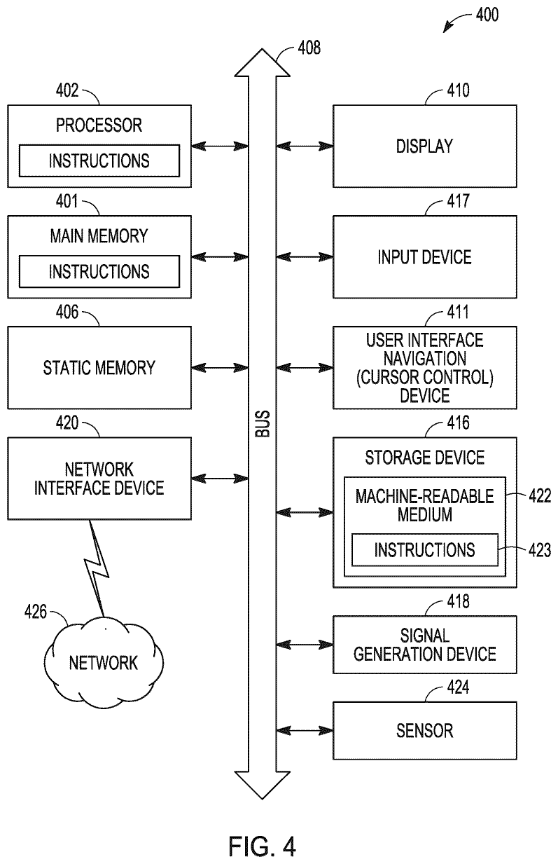

FIG. 4 is a block diagram illustrating a computing and communications platform 400 in the example form of a general-purpose machine on which some or all the operations of FIGS. 1 and 2 may be carried out according to various embodiments. In certain embodiments, programming of the computing platform 400 according to one or more particular algorithms produces a special-purpose machine upon execution of that programming. In a networked deployment, the computing platform 400 may operate in the capacity of either a server or a client machine in server-client network environments, or it may act as a peer machine in peer-to-peer (or distributed) network environments.

Example computing platform 400 includes at least one processor 402 (e.g., a central processing unit (CPU), a graphics processing unit (GPU) or both, processor cores, compute nodes, etc.), a main memory 401 and a static memory 406, which communicate with each other via a link 408 (e.g., bus). The computing platform 400 may further include a video display unit 410, input devices 417 (e.g., a keyboard, camera, microphone), and a user interface (UI) navigation device 411 (e.g., mouse, touchscreen). The computing platform 400 may additionally include a storage device 416 (e.g., a drive unit), a signal generation device 418 (e.g., a speaker), a sensor 424, and a network interface device 420 coupled to a network 426.

The storage device 416 includes a non-transitory machine-readable medium 422 on which is stored one or more sets of data structures and instructions 423 (e.g., software) embodying or utilized by any one or more of the methodologies or functions described herein. The instructions 423 may also reside, completely or at least partially, within the main memory 401, static memory 406, and/or within the processor 402 during execution thereof by the computing platform 400, with the main memory 401, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 423. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process to analyze data in an artificial neural network comprising receiving the data into the artificial neural network; functionally encrypting the data at a plurality of inner input nodes in the artificial neural network; processing the functionally encrypted data in the artificial neural network; and generating an output from the processing of the functionally encrypted data in the artificial neural network.

Example No. 2 includes all the features of Example No. 1, and optionally includes a process wherein the functionally encrypting the data comprises generating public parameters (pp) and a master secret key (msk) using a security parameter (λ); generating functional secret keys (sk_{y}) for an input function (y) using the master secret key; and functionally encrypting the data into ciphertext (c) using the master secret key.

Example No. 3 includes all the features of Example Nos. 1-2, and optionally includes a process wherein the functionally encrypted ciphertext generated by the functional encryption of the data at the plurality of inner input nodes in the artificial neural network generates ciphertext for the data and the input function of the artificial neural network, thereby protecting the data and the input function of the artificial neural network.

Example No. 4 includes all the features of Example Nos. 1-3, and optionally includes a process wherein the input function comprises a weight of a node in the artificial neural network multiplied by the data.

Example No. 5 includes all the features of Example Nos. 1-4, and optionally includes a process comprising decrypting the functionally encrypted cyphertext using the functional secret key and the public parameters.

Example No. 6 includes all the features of Example Nos. 1-5, and optionally includes a process wherein the data comprise medical image data.

Example No. 7 includes all the features of Example Nos. 1-6, and optionally includes a process wherein the output from the artificial neural network comprises a medical analysis or a medical prediction.

Example No. 8 includes all the features of Example Nos. 1-7, and optionally includes a process wherein the plurality of inner nodes comprises a plurality of nodes in a first input layer of the artificial neural network.

Example No. 9 includes all the features of Example Nos. 1-8, and optionally includes a process wherein the plurality of nodes in the first input layer of the artificial neural network comprises all the nodes in the first input layer of the artificial neural network.

Example No. 10 includes all the features of Example Nos. 1-9, and optionally includes a process wherein the data comprise training data and input data.

Example No. 11 is a machine-readable medium comprising instructions that when executed by a processor execute a process comprising receiving the data into the artificial neural network; functionally encrypting the data at a plurality of inner input nodes in the artificial neural network; processing the functionally encrypted data in the artificial neural network; and generating an output from the processing of the functionally encrypted data in the artificial neural network.

Example No. 12 includes all the features of Example No. 11, and optionally includes a machine-readable medium wherein the functionally encrypting the data comprises generating public parameters (pp) and a master secret key (msk) using a security parameter (λ); generating functional secret keys (sk_{y}) for an input function (y) using the master secret key; and functionally encrypting the data into ciphertext (c) using the master secret key.

Example No. 13 includes all the features of Example Nos. 11-12, and optionally includes a machine-readable medium wherein the functionally encrypted ciphertext generated by the functional encryption of the data at the plurality of inner input nodes in the artificial neural network generates ciphertext for the data and the input function of the artificial neural network, thereby protecting the data and the input function of the artificial neural network.

Example No. 14 includes all the features of Example Nos. 11-13, and optionally includes a machine-readable medium wherein the input function comprises a weight of a node in the artificial neural network multiplied by the data.

Example No. 15 includes all the features of Example Nos. 11-14, and optionally includes a machine-readable medium comprising instructions for decrypting the functionally encrypted cyphertext using the functional secret key and the public parameters.

Example No. 16 includes all the features of Example Nos. 11-15, and optionally includes a machine-readable medium wherein the data comprise medical image datal and wherein the output from the artificial neural network comprises a medical analysis or a medical prediction.

Example No. 17 includes all the features of Example Nos. 11-16, and optionally includes a machine-readable medium wherein the plurality of inner nodes comprises a plurality of nodes in a first input layer of the artificial neural network.

Example No. 18 includes all the features of Example Nos. 11-17, and optionally includes a machine-readable medium wherein the plurality of nodes in the first input layer of the artificial neural network comprises all the nodes in the first input layer of the artificial neural network.

Example No. 19 includes all the features of Example Nos. 11-18, and optionally includes a machine-readable medium wherein the data comprise training data and input data.

Example No. 20 is a system comprising a processor; and a memory coupled to the processor; wherein the processor and the memory are operable for analyzing data in an artificial neural network comprising receiving the data into the artificial neural network; functionally encrypting the data at a plurality of inner input nodes in the artificial neural network; processing the functionally encrypted data in the artificial neural network; and generating an output from the processing of the functionally encrypted data in the artificial neural network.

1. A process to analyze data in an artificial neural network comprising:
receiving the data into the artificial neural network;
functionally encrypting the data at a plurality of inner input nodes in the artificial neural network;
processing the functionally encrypted data in the artificial neural network; and
generating an output from the processing of the functionally encrypted data in the artificial neural network.

2. The process of claim 1, wherein the functionally encrypting the data comprises:
generating public parameters and a master secret key using a security parameter;
generating functional secret keys for an input function using the master secret key; and
functionally encrypting the data into ciphertext using the master secret key.

3. The process of claim 2, wherein the functionally encrypted ciphertext generated by the functional encryption of the data at the plurality of inner input nodes in the artificial neural network generates ciphertext for the data and the input function of the artificial neural network, thereby protecting the data and the input function of the artificial neural network.

4. The process of claim 3, wherein the input function comprises a weight of a node in the artificial neural network multiplied by the data.

5. The process of claim 2, comprising decrypting the functionally encrypted cyphertext using the functional secret key and the public parameters.

6. The process of claim 1, wherein the data comprise medical image data.

7. The process of claim 6, wherein the output from the artificial neural network comprises a medical analysis or a medical prediction.

8. The process of claim 1, wherein the plurality of inner nodes comprises a plurality of nodes in a first input layer of the artificial neural network.

9. The process of claim 8, wherein the plurality of nodes in the first input layer of the artificial neural network comprises all the nodes in the first input layer of the artificial neural network.

10. The process of claim 1, wherein the data comprise training data and input data.

11. A non-transitory machine-readable medium comprising instructions that when executed by a processor execute a process comprising:
receiving the data into the artificial neural network;
functionally encrypting the data at a plurality of inner input nodes in the artificial neural network;
processing the functionally encrypted data in the artificial neural network; and
generating an output from the processing of the functionally encrypted data in the artificial neural network.

12. The non-transitory machine-readable medium of claim 11, wherein the functionally encrypting the data comprises:
generating public parameters and a master secret key using a security parameter;
generating functional secret keys for an input function using the master secret key; and
functionally encrypting the data into ciphertext using the master secret key.

13. The non-transitory machine-readable medium of claim 12, wherein the functionally encrypted ciphertext generated by the functional encryption of the data at the plurality of inner input nodes in the artificial neural network generates ciphertext for the data and the input function of the artificial neural network, thereby protecting the data and the input function of the artificial neural network.

14. The non-transitory machine-readable medium of claim 13, wherein the input function comprises a weight of a node in the artificial neural network multiplied by the data.

15. The non-transitory machine-readable medium of claim 12, comprising decrypting the functionally encrypted cyphertext using the functional secret key and the public parameters.

16. The non-transitory machine-readable medium of claim 11, wherein the data comprise medical image datal and wherein the output from the artificial neural network comprises a medical analysis or a medical prediction.

17. The non-transitory machine-readable medium of claim 11, wherein the plurality of inner nodes comprises a plurality of nodes in a first input layer of the artificial neural network.

18. The non-transitory machine-readable medium of claim 18, wherein the plurality of nodes in the first input layer of the artificial neural network comprises all the nodes in the first input layer of the artificial neural network.

19. The non-transitory machine-readable medium of claim 11, wherein the data comprise training data and input data.

20. A system comprising:
a processor;
a memory coupled to the processor;
wherein the processor and the memory are operable for analyzing data in an artificial neural network comprising:
receiving the data into the artificial neural network;
functionally encrypting the data at a plurality of inner input nodes in the artificial neural network;
processing the functionally encrypted data in the artificial neural network; and
generating an output from the processing of the functionally encrypted data in the artificial neural network.
